(19) United States
(12) Patent Application Publication
(10) Pub. No.: US 2009/0093600 A1
(43) Pub. Date: Apr. 9, 2009

(54) Methods for Making Polyester Resins in Falling Film Melt Polycondensation Reactors

(75) Inventors: Tony Clifford Moore, Charlotte, NC (US); Sharon Sue Griffith, Charlotte, NC (US); David Eugene Thompson, Florence, SC (US); Neil Richard Kluesener, Florence, SC (US); James Reed Honeycutt, Fort Mill, SC (US)

Correspondence Address: SUMMA, ADDITON & ASHE, P.A., 11610 NORTH COMMUNITY HOUSE ROAD, SUITE 200, CHARLOTTE, NC, 28277, US

(73) Assignee: WELLMAN, INC., Fort Mill, SC (US)

(21) Appl. No.: 12/258,513

(22) Filed: Oct. 27, 2008

Related U.S. Application Data
(63) Continuation of application No. PCT/US07/67392, filed on Apr. 25, 2007.
(60) Provisional application No. 60/745,922, filed on Apr. 28, 2006.

(51) Int. Cl. C08F 2/00

(52) U.S. Cl. 526/65

(57) ABSTRACT

The present invention relates to methods for forming polyester resins in one or more falling film reactors.

### CROSS-REFERENCE TO PRIORITY APPLICATION

This application is a continuation of commonly assigned International Patent Application No. PCT/US07/67392 for Methods for Making Polyester Resins in Falling Film Melt Polycondensation Reactors, filed Apr. 25, 2007, (and published Nov. 8, 2007, as Publication No. WO2007/127786), which itself claims the benefit of commonly assigned U.S. Provisional Patent Application Ser. No. 60/745,922, for Methods for Making Polyester Resins in Falling Film Melt Polycondensation Reactors, filed Apr. 28, 2006. This nonprovisional application claims the benefit of and incorporates entirely by reference both this international application and this U.S. provisional patent application.

### CROSS-REFERENCE TO COMMONLY ASSIGNED APPLICATIONS

This application incorporates entirely by reference the following commonly assigned patent and patent applications, which disclose polymer resins and polymer processes: U.S. patent application Ser. No. 09/456,253, filed Dec. 7, 1999, for a Method of Preparing Modified Polyester Bottle Resins, now U.S. Pat. No. 6,284,866; U.S. patent application Ser. No. 09/851,240, filed May 8, 2001, for a Method of Preparing Modified Polyester Bottle Resins, now U.S. Pat. No. 6,335,422; U.S. patent application Ser. No. 10/850,269, for Methods of Making Titanium-Catalyzed Polyester Resins, filed May 20, 2004, (and published Nov. 24, 2005, as Publication No. 2005/0261462 A1); U.S. patent application Ser. No. 10/850,918, for Slow-Crystallizing Polyester Resins, filed May 21, 2004, (and published Nov. 25, 2004, as Publication No. 2004/0236066 A1), now U.S. Pat. No. 7,129,317; U.S. patent application Ser. No. 10/996,789, for Polyester Preforms Useful for Enhanced Heat-Set Bottles, filed Nov. 24, 2004, (and published Jul. 14, 2005, as Publication No. 2005/0153086 A1), now U.S. Pat. No. 7,094,863; U.S. patent application Ser. No. 11/046,481, for Methods of Making Imide-Modified Polyester Resins, filed Jan. 28, 2005, (and published Aug. 4, 2005, as Publication No. 2005/0171326 A1), now U.S. Pat. No. 7,238,770; International Patent Application No. PCT/US04/16375 for Slow-Crystallizing Polyester Resins, filed May 21, 2004, (and published Dec. 2, 2004, as Publication No. WO 2004/104080); International Patent Application No. PCT/US04/39726 for Methods of Making Titanium-Catalyzed Polyethylene Terephthalate Resins, filed Nov. 24, 2004, (and published Nov. 3, 2005, as Publication No. WO 2005/103110); International Patent Application No. PCT/US05/03149 for Imide-Modified Polyester Resins and Methods of Making the Same, filed Jan. 28, 2005, (and published Aug. 11, 2005, as Publication No. WO 2005/073272); International Patent Application No. PCT/US06/02385 for Improved Polyamide-Polyester Polymer Blends and Methods of Making the Same, filed Jan. 23, 2006, (and published Jul. 27, 2006, as Publication No. WO 2006/079044); and U.S. Provisional Patent Application Ser. No. 60/738,867, for Melt-Phase Polycondensation of Titanium-Catalyzed PET Resins, filed Nov. 22, 2005.

This application further incorporates entirely by reference the following commonly assigned patents and patent applications, which disclose methods for introducing additives to polymers: Ser. No. 08/650,291 for a Method of Post-Polymerization Stabilization of High Activity Catalysts in Continuous Polyethylene Terephthalate Production, filed May 20, 1996, now U.S. Pat. No. 5,898,058; Ser. No. 09/738,150, for Methods of Post-Polymerization Injection in Continuous Polyethylene Terephthalate Production, filed Dec. 15, 2000, now U.S. Pat. No. 6,599,596; Ser. No. 09/932,150, for Methods of Post-Polymerization Extruder Injection in Polyethylene Terephthalate Production, filed Aug. 17, 2001, now U.S. Pat. No. 6,569,991; Ser. No. 10/017,612, for Methods of Post-Polymerization Injection in Condensation Polymer Production, filed Dec. 14, 2001, now U.S. Pat. No. 6,573,359; Ser. No. 10/017,400, for Methods of Post-Polymerization Extruder Injection in Condensation Polymer Production, filed Dec. 14, 2001, now U.S. Pat. No. 6,590,069; Ser. No. 10/628,077, for Methods for the Late Introduction of Additives into Polyethylene Terephthalate, filed Jul. 25, 2003, now U.S. Pat. No. 6,803,082; and Ser. No. 10/962,167, for Methods for Introducing Additives into Polyethylene Terephthalate, filed Oct. 8, 2004, (and published Aug. 4, 2005, as Publication No. 2005/0170175 A1).

This application further incorporates entirely by reference the following commonly assigned patents and patent applications, which disclose polymer resins having reduced frictional properties and associated methods: Ser. No. 09/738,619, for Polyester Bottle Resins Having Reduced Frictional Properties and Methods for Making the Same, filed Dec. 15, 2000, now U.S. Pat. No. 6,500,890; Ser. No. 10/177,932 for Methods for Making Polyester Bottle Resins Having Reduced Frictional Properties, filed Jun. 21, 2002, now U.S. Pat. No. 6,710,158; and Ser. No. 10/176,737 for Polymer Resins Having Reduced Frictional Properties, filed Jun. 21, 2002, now U.S. Pat. No. 6,727,306.

### BACKGROUND OF THE INVENTION

Because of their strength, heat resistance, and chemical resistance, polyester containers, films, sheets, and fibers are used worldwide in numerous consumer products. In this regard, most commercial polyester used for polyester containers, films, sheets, and fibers is polyethylene terephthalate polyester.

Polyester resins, especially polyethylene terephthalate and its copolyesters, are also widely used to produce rigid packaging, such as two-liter soft drink containers. Two-liter bottles and other polyester packaging produced by stretch-blow molding possess outstanding strength and shatter resistance, and have excellent gas barrier and organoleptic properties as well. Consequently, polyethylene terephthalate and other lightweight plastics have virtually replaced glass in packaging numerous consumer products (e.g., carbonated soft drinks, fruit juices, and peanut butter).

In a conventional process for making polyester resins, modified polyethylene terephthalate is polymerized in the melt phase to an intrinsic viscosity of about 0.6 dL/g, whereupon it is further polymerized in the solid phase to achieve an intrinsic viscosity that better promotes bottle formation. Thereafter, the polyethylene terephthalate may be formed into articles, such as by injection molding preforms, which in turn may be stretch-blow molded into bottles.

As an improvement to this conventional process, it would be advantageous to make polyester resins in a way that reduces or even eliminates the capital costs (e.g., additional vessels) and energy costs associated with solid state polymerization.

### SUMMARY OF THE INVENTION

Accordingly, it is an object of the present invention to provide methods for efficiently making condensation polymers, particularly polyethylene terephthalate resins, via melt phase polycondensation.

It is a further object of the present invention to provide methods for achieving, via melt phase polycondensation, polyethylene terephthalate resins having relatively high intrinsic viscosities to facilitate their use in bottles, sheets, films, fibers, and other articles.

It is a further object of the present invention to provide a falling film reactor system that provides significantly faster intrinsic viscosity lift as compared with conventional solid state polymerization systems.

It is a further object of the present invention to provide a falling film reactor system that provides efficient intrinsic viscosity lift of 0.10 dL/g or more (e.g., 0.25 dL/g or more).

It is a further object of the present invention to provide a falling film reactor system that has improved economics with respect to equipment and energy costs.

It is a further object of the invention to provide a falling film reactor system that is capable of employing various polycondensation catalysts, such as antimony, titanium, aluminum, and germanium.

It is a further object of the invention to provide a falling film reactor system that can introduce stabilizers (e.g., phosphorus-based stabilizers) before, during, and/or after the falling film melt polycondensation.

It is a further object of the invention to provide a falling film reactor system that can introduce antioxidants before, during, and/or after falling film melt polycondensation.

It is a further object of the invention to provide a falling film reactor system that can introduce other additives before, during, and/or after falling film melt polycondensation.

The foregoing, as well as other objectives and advantages of the invention and the manner in which the same are accomplished, is further specified within the following detailed description and its accompanying figures.

### BRIEF DESCRIPTION OF THE DRAWINGS

FIG. 1 depicts a simplified process for the melt phase, falling film polycondensation of low molecular weight polyethylene terephthalate oligomers that are achieved during esterification.

FIG. 2 depicts a simplified process for the melt phase, falling film polycondensation of higher molecular weight polyethylene terephthalate prepolymers or lower molecular weight polyethylene terephthalate polymers that are achieved during initial melt phase polycondensation.

FIG. 3 depicts increasing polymer molecular weight as a function of decreasing water concentration in the polymer melt.

FIG. 4 depicts the effective maximum carboxyl-end-group concentrations for polyethylene terephthalate as a function of solution intrinsic viscosity.

FIG. 5 depicts (i) total-end-group concentrations for polyethylene terephthalate as a function of solution intrinsic viscosity and (ii) exemplary carboxyl-end-group concentrations for antimony-catalyzed polyethylene terephthalate as a function of solution intrinsic viscosity.

FIG. 6 depicts (i) total-end-group concentrations for polyethylene terephthalate as a function of solution intrinsic viscosity and (ii) exemplary carboxyl-end-group concentrations for titanium-catalyzed polyethylene terephthalate as a function of solution intrinsic viscosity.

### DETAILED DESCRIPTION

In one aspect, the invention embraces methods for making polyester resins, particularly polyethylene terephthalate resins, via falling film melt polycondensation.

Those having ordinary skill in the art will know that there are two primary methods for making polyethylene terephthalate. Each of these methods reacts a terephthalate component and a diol component (i.e., a terephthalate moiety and a diol moiety) to form polyethylene terephthalate prepolymers, which are then polymerized via melt phase polycondensation to form polyethylene terephthalate polymers.

The first method involves a two-step ester exchange reaction and polymerization using dimethyl terephthalate and excess ethylene glycol. In this technique, the aforementioned step of reacting a terephthalate component and a diol component includes reacting dimethyl terephthalate and ethylene glycol in a heated, catalyzed ester exchange reaction (i.e., transesterification) to form bis(2-hydroxyethyl)terephthalate monomers, as well as methanol as a byproduct. To enable the ester exchange reaction to go essentially to completion, methanol is continuously removed as it is formed. The bis(2-hydroxyethyl)terephthalate monomer product is then catalytically polymerized via polycondensation (i.e., melt phase and/or solid state polymerization) to produce polyethylene terephthalate polymers.

The second method employs a direct esterification reaction using terephthalic acid and excess ethylene glycol. In this technique, the aforementioned step of reacting a terephthalate component and a diol component includes reacting terephthalic acid and ethylene glycol in a heated esterification reaction to form monomers and oligomers of terephthalic acid and ethylene glycol, as well as water as a byproduct. To enable the esterification reaction to go essentially to completion, water is continuously removed as it is formed. The monomers and oligomers are subsequently catalytically polymerized via polycondensation (i.e., melt phase and/or solid state polymerization) to form polyethylene terephthalate polyester. Ethylene glycol is continuously removed during polycondensation to create favorable reaction kinetics.

The polyethylene terephthalate polymers achieved via direct esterification of terephthalic acid are substantially identical to the polyethylene terephthalate polymers achieved via ester interchange of dimethyl terephthalate, albeit with some minor chemical differences (e.g., end group differences). As compared with the transesterification of dimethyl terephthalate, the direct esterification of terephthalic acid is not only more economical but often yields polyethylene terephthalate resins having better color.

The present invention particularly embraces direct esterification of terephthalic acid followed by melt phase polycondensation in a falling film reactor system. In this regard, there are two conceptual models for employing a falling film polycondensation system according to the present invention.

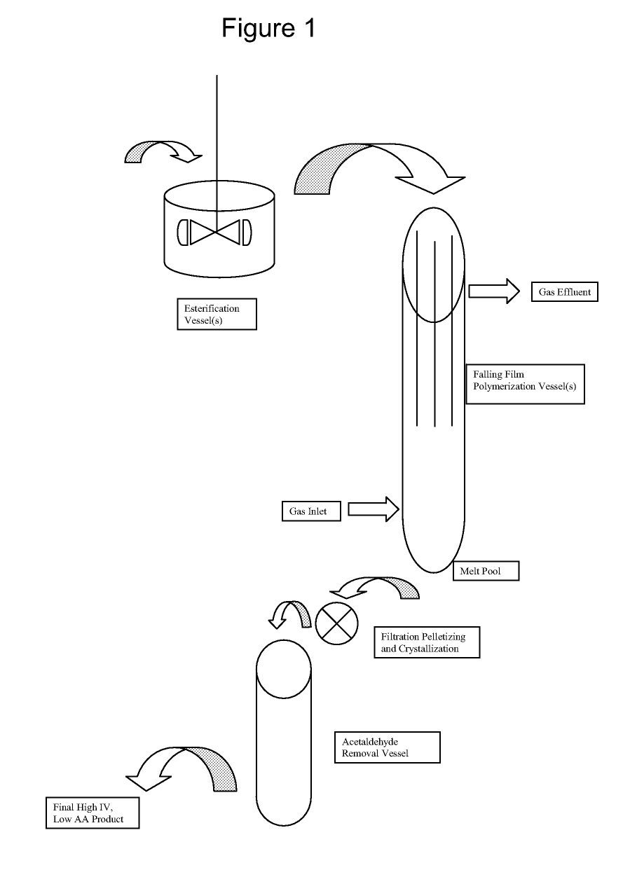

As depicted in FIG. 1, in one conceptual aspect the invention employs the direct esterification of terephthalic acid in one or more esterification reaction vessels to form polyethylene terephthalate oligomers. These polyethylene terephthalate oligomers are then fed more or less directly to a falling film reactor system to effect polycondensation polymerization. The falling film reactor system may employ one or more falling film reactors in series, parallel, or both. This conceptual aspect of the invention may be exemplified by the falling film melt polycondensation of the polyethylene terephthalate oligomers that are achieved during esterification.

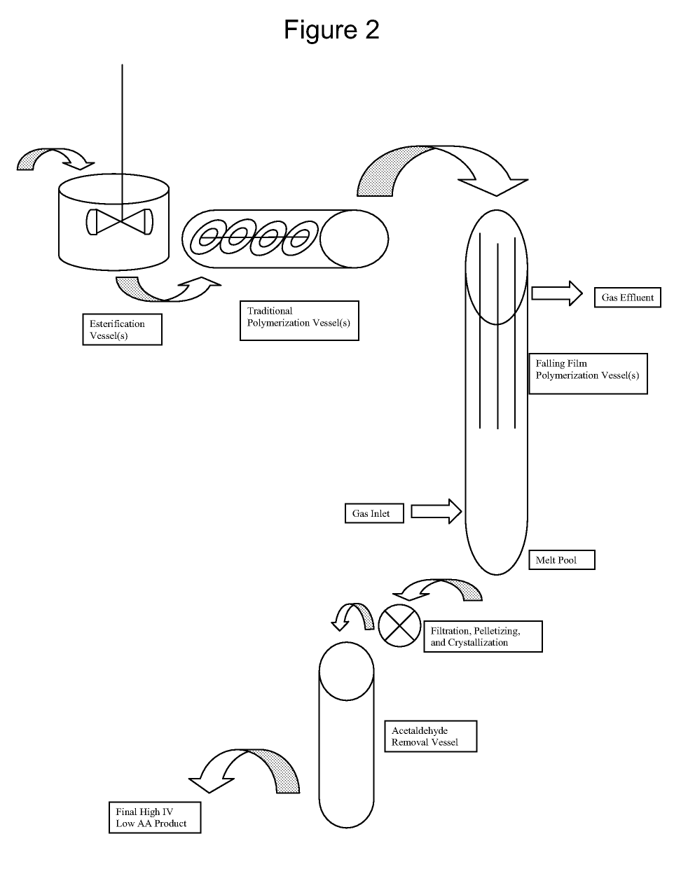

As depicted in FIG. 2, in another conceptual aspect the invention likewise employs the direct esterification of terephthalic acid in one or more esterification reaction vessels to form monomers and oligomers of polyethylene terephthalate. In contrast to the first conceptual model, the second conceptual model feeds the polyethylene terephthalate monomers and oligomers that are produced during esterification to one or more standard polymerizers to increase molecular weight. These polymerizers yield higher molecular weight polyethylene terephthalate prepolymers (and/or lower molecular weight polyethylene terephthalate polymers), which are thereupon fed to the falling film reactor system for further melt phase polycondensation. As with the first conceptual model, the falling film reactor system may employ one or more falling film reactors in series, parallel, or both. This aspect of the invention may be exemplified by the falling film melt polycondensation of higher molecular weight polyethylene terephthalate prepolymers or lower molecular weight polyethylene terephthalate polymers that are achieved during initial melt phase polycondensation (i.e., within the one or more standard polymerizer vessels).

It is expected that polyethylene terephthalate monomers and oligomers that are produced during esterification will have to be polymerized under reduced pressure (i.e., less than atmospheric pressure) before the initiation of falling film melt polycondensation. Otherwise, the intermediate product that is fed to the falling film reactor system might be incapable of acceptable film formation.

For example, the monomers and oligomers that are achieved during esterification would have low surface tension, thereby complicating the formation of a falling film. As discussed herein, the intermediate product (prepolymer or polymer) that is to be fed to the falling film reactor system must have sufficient melt viscosity and surface tension to promote good film formation. Accordingly, the invention according to the latter conceptual aspect (i.e., employing initial melt phase polycondensation before falling film melt polycondensation) is expected to be more commercially practical.

In another aspect, the invention embraces falling film reactor systems that provide efficient melt phase polycondensation of polyethylene terephthalate polymers. The falling film reactor systems can embrace various designs and configurations but, at steady state, must facilitate the formation of a falling film within reactor in a way that maintains constant mass flow rate throughout the reactor (i.e., from top to bottom).

In this regard, the falling film reactor is a substantially vertical tower (e.g., a cylindrical pipe reactor) that includes packing or fill. As used herein, the term “packing” refers to both random packing (e.g., rings or saddles) and regular packing (e.g., trays, plates, sheets, grids, and/or wires). One exemplary falling film tower is disclosed in International Publication No. WO 2005/044417 A1, published May 19, 2005, from International Application No. PCT/CN2004/001194 (Liu Zhaoyan et al.), filed Oct. 21, 2004 (designating the United States). International Publication No. WO 2005/044417 A1 and its counterpart U.S. Publication No. 2007/0164462 A1 (published Jul. 19, 2007) are hereby incorporated by reference in their entirety. Typically, to control capital costs, the packing is not adjustable within the reactor during normal operations.

That said, it is within the scope of the present falling film reactor systems to include adjustable, regular packing (e.g., moveable wires and/or adjustable plates) to facilitate subsequent process adjustments. This may be beneficial to provide process flexibility in circumstances where, for instance, (i) the reactor is to be employed with differing feeds (e.g., prepolymers of varying melt viscosity) or (ii) polymer overflow is occurring within the falling film reactor (e.g., the prepolymer or polymer is bypassing one or more plates or trays).

At steady-state operation, the falling film reactor system according to the present invention should maintain a constant mass flow rate along the reactor's height yet promote effective surface-area generation (i.e., film formation) in a way that avoids packing overflow. Polymerization is effected via directed gravitational flow through a substantially static packing.

In accordance with the present invention, “falling film” embraces prepolymer and/or polymer that possesses a relatively higher surface-to-volume ratio as compared to a conventional polymerizer. The generation and regeneration of falling films is dynamic. Therefore, falling films as described herein are intended to include not only polymer sheets but also other high-surface-area polymer geometries, such as globules, bubbles, and annular tubes.

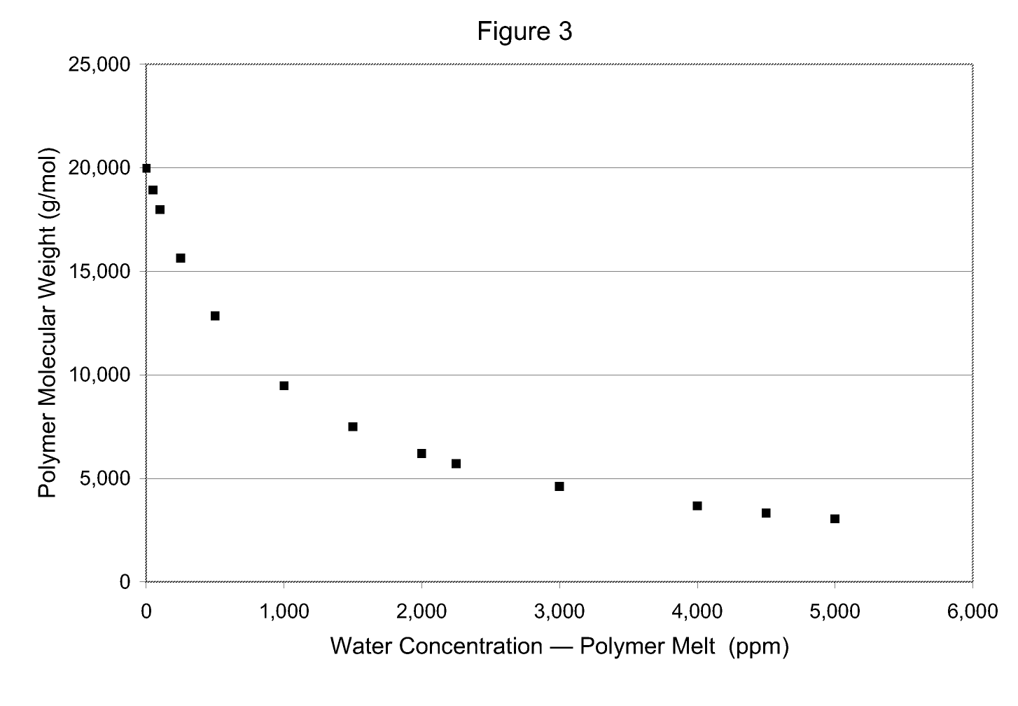

Those having ordinary skill in the art will appreciate the importance of surface generation (including regeneration) during polycondensation reactions. In this regard, polycondensation will advance (i.e., increase molecular weight) where vapor reaction byproducts (e.g., water, ethylene glycol, and acetaldehyde) are liberated into the vapor space within the falling film reactor (i.e., at the vapor-liquid interface). This removal of byproducts minimizes reverse equilibrium reactions, thereby forcing the reaction kinetics toward continued polymer formation. FIG. 3 illustrates how the removal of reaction byproducts—here, water—at the vapor-liquid interface yields higher molecular weight products.

In a conventional polymerizer, surface area generation occurs only where the prepolymer and/or polymer is lifted (e.g., mechanically agitated) out of the melt pool. In contrast, in the falling film reactor systems according to the present invention, surface area generation substantially reduces the amount of prepolymer and/or polymer in a pooled state (i.e., the prepolymer and/or polymer defines a much greater vapor-liquid interface). Consequently, the falling film reactor systems according to the present invention provide significantly faster intrinsic viscosity lift to higher molecular weight resins (e.g., to an intrinsic viscosity of 0.80 dL/g or so) as compared with conventional polymerization systems, thereby reducing capital and operating costs.

In an exemplary process according to the present invention, a continuous feed of terephthalic acid (and up to about 30 mole percent of other diacids) and excess ethylene glycol (and up to about 30 mole percent of other diols) enters a direct esterification vessel. The esterification vessel is operated at a temperature of between about 240° C. and 290° C. (e.g., 260° C.) and at a pressure of between about 5 and 85 psia (e.g., atmospheric pressure) for between about one and five hours. The esterification reaction forms low molecular weight monomers, oligomers, and water. The water is removed as the reaction proceeds to provide favorable reaction equilibrium.

The molar ratio of ethylene glycol to terephthalic acid is typically more than 1.0 and less than about 1.5 (e.g., 1.05-1.45), more typically less than 1.4 (e.g., 1.15-1.3), and most typically less than 1.3 (e.g., 1.1-1.2). As discussed herein, however, higher fractions of excess ethylene glycol (e.g., a molar ratio of about 1.15 to 1.3) may be desirable to reduce the acidity of the esterification product (i.e., the carboxyl end group concentration of the polyethylene terephthalate prepolymers that are obtained during esterification). On the other hand, higher mole ratios encourage the formation of diethylene glycol and so, as a practical matter, mole ratios should be capped.

Those having ordinary skill in the art will understand that rather than using a single esterification vessel, exemplary processes may employ two or more direct esterification vessels, such as a primary esterifier and a secondary esterifier. In an exemplary configuration employing two esterifiers in series, the primary esterifier will typically produce polyethylene terephthalate monomers, dimers, trimers, and such (i.e., oligomers), which are then fed directly to the secondary esterifier. Esterification within the secondary esterifier continues to yield polyethylene terephthalate prepolymers having an average degree of polymerization greater than about 4, typically between about 6 and 14 (e.g., about 8-12).

As noted previously, the polyethylene terephthalate oligomers achieved during esterification may be fed directly to a falling film reactor. Alternatively, the polyethylene terephthalate oligomers may be fed first into one or more polymerizers (configured in series and/or parallel) to increase molecular weight and from there to a falling film reactor.

In one process embodiment, therefore, the polyethylene terephthalate oligomers are fed more or less directly to a first-stage falling film reactor. See FIG. 1. A distribution manifold delivers the polyethylene terephthalate oligomers to the packing within the falling film reactor. Within the falling film reactor, the polyethylene terephthalate oligomers are polymerized via melt phase polycondensation to form polyethylene terephthalate polyester. Polycondensation within the falling film reactor will typically proceed under vacuum and at a temperature less than about 290° C., typically between about 240° C. and 275° C., more typically between about 245° C. and 270° C. (e.g., 250° C.-265° C.). To minimize the formation of acetaldehyde and other unwanted byproducts, the falling film reactor should be operated near the melting peak temperature (T_{M}) of the polyethylene terephthalate polymers. Unless otherwise noted, melting peak temperature (T_{M}) is herein reported at a heating rate of 10° C. per minute as measured by differential scanning calorimetry (DSC) thermal analyses.

In another, more commercially viable process embodiment, the polyethylene terephthalate oligomers achieved during esterification are fed to one or more standard polymerizers to increase the molecular weight of the prepolymers, typically to an intrinsic viscosity of at least about 0.25 dL/g (e.g., 0.3-0.4 dL/g). In some process embodiments, such standard polymerizers yield lower molecular weight polyethylene terephthalate polymers (i.e., possessing an intrinsic viscosity of at least about 0.45 dL/g, such as 0.5-0.65 dL/g). See FIG. 2. As before, a distribution manifold delivers the polyethylene terephthalate prepolymers and polymers to the packing within the falling film reactor.

Polymerizer vessels are typically arranged in series (e.g., a low polymerizer then a high polymerizer). During initial polycondensation, the temperature is generally increased and the pressure decreased to allow greater polymerization within successive vessels. In addition, to promote favorable reaction kinetics, ethylene glycol is continuously removed during initial polycondensation. The intermediate product from this initial polycondensation (i.e., higher molecular weight prepolymers or lower molecular weight polymers) is fed to the falling film reactor to be further polymerized via melt phase polycondensation and thereby lift intrinsic viscosity 0.10 dL/g or more (e.g., 0.15-0.30 dL/g).

As in the other process embodiment, melt phase polycondensation within the falling film reactor will proceed under vacuum, typically at a temperature less than about 290° C., typically between about 240° C. and 275° C. (e.g., 245° C.-270° C.). As before, to minimize the formation of acetaldehyde and other unwanted byproducts (e.g., cyclic trimers), the falling film reactor should be operated near the melting peak temperature (T_{M}) of the polyethylene terephthalate polymers.

Those having ordinary skill in the art will understand that, if the formation of acetaldehyde and other unwanted byproducts is less of a concern, then falling film reactor temperatures may be increased to 300° C. or so, typically less than 295° C. (e.g., 275° C.-285° C.). This may be desirable, for instance, if the process employs post-polymerization unit operations for reducing acetaldehyde and cyclic trimers.

That said, it has been observed that intrinsic viscosity lift is less dependent upon temperature in the present falling film reactor system than is the case in a conventional polymerizer. Surprisingly, test data indicate that, under otherwise identical process conditions (e.g., a reduced pressure of 3.6 torr within the reactor), increasing reactor feed temperature has relatively little effect upon intrinsic viscosity lift.

TABLE 1

| reactor feed | inlet intrinsic | outlet intrinsic |
|---|---|---|
| temperature (° C.) | viscosity (dL/g) | viscosity (dL/g) |
| 273 | 0.530 | 0.751 |
| 278 | 0.530 | 0.769 |
| 284 | 0.530 | 0.792 |

As shown in Table 1 (above), increasing reactor feed temperature by 11° C. increases intrinsic viscosity just over 0.04 dL/g. By way of comparison, a similar temperature increase in a conventional polymerizer would likely increase intrinsic viscosity by more than 0.20 dL/g (i.e., about 5×)

Depending upon the intrinsic viscosity of the polyethylene terephthalate prepolymers and the target molecular weight of the polyethylene terephthalate resin (i.e., the final product), using more than one falling film reactor may be advantageous. For instance, it is expected that raising intrinsic viscosity from 0.1 dL/g to 0.8 dL/g may be most difficult within a single falling film reactor (of a reasonable height). Therefore, a series of falling film reactors may be employed to increase the molecular weight of the polyethylene terephthalate prepolymers and, thereafter, the polyethylene terephthalate polymers. In this regard, intrinsic viscosity lift of 0.3 dL/g to 0.4 dL/g is practical in a single falling film reactor according to the present invention, especially at lower starting intrinsic viscosities.

By way of example, the monomers and oligomers achieved during esterification may be subjected to reduced pressure in a flash polymerization vessel to remove free ethylene glycol and to increase intrinsic viscosity to about 0.2 dL/g. Thereafter, the resulting polyethylene terephthalate prepolymer may be directed to the falling film reactor system for additional melt phase polycondensation. An initial falling film reactor might be configured to raise the intrinsic viscosity of polyethylene terephthalate prepolymers from about 0.2 dL/g to about 0.45 dL/g (i.e., to thereby achieve lower molecular weight polymers). A subsequent falling film reactor, positioned in series, might be configured to raise the intrinsic viscosity of the resulting polyethylene terephthalate polymers from 0.45 dL/g to 0.8 dL/g. Those having ordinary skill in the art will appreciate that the falling film reactor system according to the present invention may be configured to include several falling film reactors in series, parallel, or both.

Those having ordinary skill in the art will appreciate that to effect film formation within the falling film reactor the polyethylene terephthalate prepolymers or polymers must possess adequate melt viscosity. In this regard, polyethylene terephthalate polymers having a zero-shear melt viscosity of at least about 100 Pa-sec at about 260° C. should provide acceptable film formation within the falling film reactor, at least for an intrinsic viscosity range of between about 0.45 dL/g and 0.60 dL/g.

Table 2 (below) provides representative zero-shear melt viscosity test data for polyethylene terephthalate prepolymers and polymers that were formed into falling films in accordance with the present invention:

TABLE 2

| | zero-shear | zero-shear |
|---|---|---|
| intrinsic viscosity | melt viscosity | melt viscosity |
| (dL/g) | (Pa-sec at 260° C.) | (Pa-sec at 270° C.) |
| 0.3 | 5-10 | 3-10 |
| 0.4 | 30-40 | 20-30 |
| 0.5 | 100-120 | 80-100 |
| 0.6 | 280-300 | 220-240 |
| 0.7 | 650-675 | 515-535 |
| 0.8 | 1325-1375 | 1050-1100 |

Those having ordinary skill in the art will appreciate that polyester formulation (e.g., chain branching content or comonomer kind and fraction) may influence zero-shear melt viscosity.

The terms “melt viscosity” and “intrinsic viscosity” are used herein in their conventional sense. Melt viscosity represents the resistance of molten polymer to shear deformation or flow as measured at specified conditions. Melt viscosity is primarily a factor of intrinsic viscosity, shear, and temperature.

Melt viscosity can be measured and determined without undue experimentation by those of ordinary skill in this art. For example, the zero-shear melt viscosity at a particular temperature can be calculated by employing ASTM Test Method D-3835-93A using a Kayeness Galaxy 5 capillary melt rheometer with a 0.30-inch (diameter) by 1-inch (length) to determine melt viscosities at several shear rates between about 35 sec⁻¹ and 4000 sec⁻¹, and thereafter extrapolating these melt viscosities to zero using the Modified Cross Method. In calculating zero-shear viscosity, it is recommended that several low shear rates, (e.g., less than 100 sec⁻¹), be included to ensure that the extrapolation to zero is accurate.

As used herein, the term “intrinsic viscosity” is the ratio of the specific viscosity of a polymer solution of known concentration to the concentration of solute, extrapolated to zero concentration. Intrinsic viscosity, which is widely recognized as standard measurements of polymer characteristics, is directly proportional to average polymer molecular weight. See, e.g., Dictionary of Fiber and Textile Technology, Hoechst Celanese Corporation (1990); Tortora & Merkel, Fairchild's Dictionary of Textiles (7^{th} Edition 1996).

Intrinsic viscosity can be measured and determined without undue experimentation by those of ordinary skill in this art. For the intrinsic viscosity values described herein, the intrinsic viscosity is determined by dissolving the copolyester in orthochlorophenol (OCP), measuring the relative viscosity of the solution using a Schott Autoviscometer (AVS Schott and AVS 500 Viscosystem), and then calculating the intrinsic viscosity based on the relative viscosity. See, e.g., Dictionary of Fiber and Textile Technology (“intrinsic viscosity”).

In particular, a 0.6-gram sample (+/−0.005 g) of dried polymer sample is dissolved in about 50 ml (61.0-63.5 grams) of orthochlorophenol at a temperature of about 105° C. Fibrous samples are typically cut into small pieces, whereas chip samples are ground. After cooling to room temperature, the solution is placed in the viscometer at a controlled, constant temperature, (e.g., between about 20° C. and 25° C.), and the relative viscosity is measured. As noted, intrinsic viscosity is calculated from relative viscosity.

In general, polyethylene terephthalate prepolymers having an average degree of polymerization of at least 10 or so might facilitate satisfactory film formation within the falling film reactor. It is expected that polyethylene terephthalate polymers (e.g., high polymers having an average degree of polymerization of at least about 70) will possess sufficient viscosity to achieve film formation. If, however, the polyethylene terephthalate polymers have achieved somewhat higher molecular weights (e.g., high polymers having an average degree of polymerization of at least about 100), it may be necessary to introduce low molecular weight surfactants or chemical foaming agents (or anti-foaming agents) to the polymer melt in order to change surface tension within the falling film reactor and thereby improve falling film flow through the vertical reactor (i.e., create a preferred flow pattern). For polyethylene terephthalate polymers, a degree of polymerization of about 70 corresponds to an intrinsic viscosity of about 0.45 dL/g and a degree of polymerization of about 100 corresponds to an intrinsic viscosity of about 0.61 dL/g.

As will be understood by those of ordinary skill in the art, macromolecules having a degree of polymerization of about 70 are considered high polymers. For polyethylene terephthalate, this roughly translates to a molecular weight of at least about 13,000 g/mol. At this molecular weight, polyethylene terephthalate polymers possess sufficient molecular weight, mechanical properties, melt strength, and crystallinity to facilitate polymer processing. As used herein and unless otherwise specified, molecular weight refers to number-average molecular weight rather than weight-average molecular weight.

The falling film reactors of the present invention may include heaters as internal reactor components. Such internal heaters warm reactor surfaces, particularly to facilitate reactor startup. During steady-state operation, however, it is expected that heaters will not be used to heat the falling polymer film. In other words, the packing within the falling film reactor is not directly heated; to reduce degradation reactions, no conductively heated element of the falling film reactor contacts the prepolymer product before the formation of the polyethylene terephthalate resin. Rather, polyethylene terephthalate prepolymers (or polymers) may be introduced to the falling film reactor inlet at a maximum process temperature (i.e., relative to that falling film reactor). The polyethylene terephthalate prepolymers (or polymers) should undergo some cooling during the descent through the falling film reactor; the melt phase polycondensation is an endothermic reaction and the removal of ethylene glycol and water freed during polycondensation provides evaporative cooling.

In brief, the first falling film reactor's inlet temperature could be as high as 295° C. (e.g., 250-275° C.) and its outlet temperature could be as low as 230° C. (e.g., 240° C.-270° C.). The falling film reactors of the present invention may further include heaters at the reactor bottom (i.e., the melt pool) to maintain the polymer melt at temperatures between about 240° C.-270° C. This will likely be necessary to maintain a pumpable melt viscosity.

It is expected that process temperatures will increase or remain constant from esterification to initial polycondensation, if any, to the start of falling film melt polycondensation (i.e., less than about 295° C.). See FIG. 2. In most circumstances it would be undesirable, for instance, to operate the last initial polycondensation vessel at a temperature substantially greater than the inlet temperature at the first falling film reactor. Such a process configuration would require the polyethylene terephthalate prepolymers or polymers that emerge from initial polycondensation to be cooled before undergoing falling film melt polycondensation (i.e., an inefficient cooling step). Indeed, the inlet temperature at the first falling film reactor is typically between about −5° C. and 0° C. of the outlet temperature of the last initial polycondensation vessel.

Those having ordinary skill in the art will appreciate that one advantage of a falling film reactor is that moving, mechanical parts (e.g., agitators) are not be required within the falling film reactor to generate surface area. Instead, the falling film reactor is designed to promote passive surface-area generation of the falling film (i.e., the polymer melt)—gravitational flow through a substantially static packing—to thereby release ethylene glycol and unwanted byproducts. (As used herein, a substantially static packing is intended to differentiate the present falling film reactor system, which employs passive mixing, from active, mechanical agitation.) In contrast, conventional polycondensation vessels are mechanically agitated under vacuum to promote the release of reaction and degradation byproducts from the polymer melt. Accordingly, as used herein, the concept of “passive surface-area generation” is used herein to differentiate surface-generation in the falling film reactors according to the present invention from the kinds of continuous, mechanical mixing employed in conventional polymerizers, such as horizontal agitators, vertical agitators, and rotating disks (solid or screened).

A falling film reactor according to the present invention will likely operate under reduced pressure to remove excess ethylene glycol, water, and other unwanted byproducts that emerge from the polymer melt. It is expected that the respective falling film reactors will typically operate at less than about 70 torr (e.g., 10-60 mm Hg) and perhaps less than about 20 torr (e.g., 0.1-10 mm Hg). Ethylene glycol removal is an important factor in promoting polycondensation. As noted previously, polycondensation occurs mostly at the vapor-liquid interface (i.e., the surface) where reaction byproducts can be readily removed from the polymer melt and thereby permit the polycondensation reaction to move forward.

Alternatively, the falling film reactor may employ countercurrent gas flow to remove from the polymer melt unwanted reaction byproducts, such as acetaldehyde. In this regard and by way of example, clean inert gas may be introduced near the polymer outlet at the bottom of the falling film reactor. As the inert gas passes through the reactor, it removes unwanted byproducts and impurities. The off-gases that emerge from the falling film reactor (i.e., above the inert gas inlet) are rich in these unwanted reaction byproducts (e.g., ethylene glycol and water) and impurities. The off-gases may be subjected to a cleanup system to remove these unwanted reaction byproducts and impurities. After being scrubbed, combusted, oxidized, or otherwise cleaned to remove, for instance, oxygen and reaction byproducts, the inert gas can be reintroduced into the falling film reactor in a relatively pure form. Alternatively, a concurrent or cross-flow of clean inert gas can be employed to carry off unwanted byproducts and impurities.

Recycled gas unit operations of this kind may employ various systems to remove the unwanted reaction byproducts and impurities from the off-gases. For example, chilled ethylene glycol sprays may be employed to create a barrier through which condensables and solids within the contaminated gas will not readily pass. Alternatively, molecular sieves may be employed to remove gas impurities or catalyst beds may be employed to facilitate the combustion of impurities. In addition, combinations of these unit operations can be employed to ensure that the off-gases are sufficiently clean to permit recycle within the falling film reactor. If necessary, all or a portion of the off-gases may be directed to a combustion unit. Such diversion, however, will require fresh gas make-up, which must be heated prior to introduction into the falling film reactor. Exemplary systems for removing unwanted reaction byproducts from reactor off-gases are disclosed in U.S. Pat. Nos. 5,547,652; 6,548,031; 6,703,479; and 6,749,821. Each of these U.S. patents is hereby incorporated by reference in its entirety.

Typically, the polyethylene terephthalate polymer emerging from the falling film reactor will have an intrinsic viscosity sufficient for use as a polyester resin (e.g., 0.70-0.95 dL/g). As noted, the polyethylene terephthalate polymer is expected to exit the falling film reactor at a temperature less than about 290° C., such as between about 240° C. and 270° C. Thereafter, the polyethylene terephthalate may be pelletized, then crystallized.

Reaction byproducts will continue to form after the polyethylene terephthalate exits the falling film reactor, but degassing the polymer (e.g., vacuum polycondensation or countercurrent gas flow) now becomes impractical. Consequently, the polyethylene terephthalate polymers should be pelletized and crystallized soon after exiting the falling film reactor. That said, in some configurations it may be practical, if not desirable, to de-volatilize the polymer melt immediately before pelletization.

Pelletization may be achieved, for instance, by strand pelletization or underwater pelletization. In strand pelletization, the polymer melt is typically filtered (or otherwise screened) and extruded, then quenched, such as by spraying with cold water. The polyethylene terephthalate polyester strand is then cut into chips or pellets for storage and handling purposes.

In underwater pelletization, the polymer melt is likewise filtered (or otherwise screened) but extruded through a die directly into water. The polymer extrudate is separated while immersed in water to form molten droplets. Without being bound to any theory, it is thought that surface tension causes the molten droplet to form spherical pellets (i.e., spheroids). As will be appreciated by those having ordinary skill in the art, spherical pellets permit only point contact, thereby minimizing sticking during subsequent unit operations (e.g., crystallization). To facilitate crystallization, pelletization should yield pellets having a stable, cool surface but largely retaining their heat.

As used herein, the term “pellets” is used generally to refer to chips, pellets, and the like. Such polyester pellets typically have an average mass of about 10-25 mg.

Typically, crystallization of pellets (i) is initiated by quenching the pellets in hot water (e.g., 80-95° C.), then (ii) is continued to at least about 30 percent crystallinity (e.g., 35-45 percent crystallinity) using internal latent heat. Higher quenching temperatures may be employed if the water is pressurized. After quenching, the pellets might possess surface temperatures between about 130° C. and 170° C. (e.g., 140° C.-160° C.) as measured by infrared measuring device. This kind of hot-water crystallization, for example, may further include subsequent drying operations. Such drying unit operations (e.g., flash drying to remove surface moisture) are well within the understanding of those having ordinary skill in the art.

Satisfactory techniques for underwater pelletization and thermal crystallization are disclosed in U.S. Patent Application Publication No. US2005/0085620 A1 (Bruckmann), which is hereby incorporated by reference in its entirety. Alternatively, crystallization can be achieved, for instance, via hot-air crystallization, fluidized-bed crystallization, or mechanically agitated crystallization. See e.g., U.S. Pat. Nos. 4,370,302; 5,410,984; 5,440,005; 5,454,344; 5,497,562; 5,523,064; 5,532,335; 5,634,282; and 5,662,870; 5,711,089; 6,713,600; and 6,767,520. Each of these U.S. patents is hereby incorporated by reference in its entirety.

After initial crystallization (and drying), the polyethylene terephthalate polymers should possess less than about 50 ppm acetaldehyde, typically less than about 30 ppm acetaldehyde, and more typically less than about 10 ppm acetaldehyde. To reduce acetaldehyde content, the polyethylene terephthalate polymers may be subjected to elevated temperatures long enough to reduce the acetaldehyde content to less than about 5 ppm, typically less than about 2 ppm (e.g., less than about 1 ppm).

In this regard, the polyethylene terephthalate pellets may be subjected to recirculated or single-pass air having a temperature of less than about 185° C. Typically, the air is dry in order to minimize polymer hydrolytic degradation.

Surprisingly, it has been determined that wet air (e.g., ambient air) can be used at relatively lower temperatures (e.g., heated to between about 130° C. and 180° C.) to reduce acetaldehyde content without causing significant hydrolytic degradation (i.e., intrinsic viscosity loss). In this regard, to reduce acetaldehyde in the polyethylene terephthalate resin, filtered and heated but otherwise raw ambient air may be used—perhaps even raw ambient air that is saturated at about 30-40° C. (i.e., typical summertime conditions in the southern part of the United States). To avoid molecular weight reduction and degradation reactions, it is thought that capping air temperatures at less than about 180° C. renders moisture content somewhat less important to acetaldehyde-reduction processes.

Alternatively, prior to acetaldehyde reduction processes, ambient air may be first dried to a dew point of greater than −20° C., typically more −10° C. Those having ordinary skill in the art will appreciate that ambient air may be cost-effectively dried—fully or partially—to a dew point of greater than 0° C. (e.g., about 10° C.).

To demonstrate the practicality of using raw ambient air in post-polymerization unit operations, amorphous polyethylene terephthalate resin, which was made using the present falling film reactor system, was subjected to crystallization and subsequent acetaldehyde removal. Table 3 (below) provides test data for polyethylene terephthalate polymers during crystallization at 250° F. (i.e., about 120° C.) and subsequent acetaldehyde reduction at 340° F. (i.e., about 170° C.) using raw ambient air having a dew point of 30° F. (i.e., about 0° C.):

TABLE 3

| | | intrinsic |
|---|---|---|
| | acetaldehyde | viscosity |
| polymer description | (ppm) | (dL/g) |
| 1. amorphous polyethylene terephthalate resin | 12.74 | 0.870 |
| 2a. crystallization (after 2.5 hours at 250° F.) | 8.62 | 0.867 |
| 2b. crystallization (after 3.0 hours at 250° F.) | 6.86 | 0.864 |
| 2c. crystallization (after 5.0 hours at 250° F.) | 6.71 | 0.866 |
| 3a. acetaldehyde removal (after 2.5 hours | 3.78 | 0.867 |
| at 340° F.) | | |
| 3b. acetaldehyde removal (after 5.0 hours | 2.22 | 0.874 |
| at 340° F.) | | |
| 3c. acetaldehyde removal (after 18.0 hours | 1.27 | 0.875 |
| at 340° F.) | | |

Table 3 demonstrates that acetaldehyde reduction can be effectively achieved using air having a dew point of between −5° C. and 5° C. without hydrolytic degradation (i.e., intrinsic viscosity loss). Moreover, as illustrated in Table 3, air temperatures typical to achieve acetaldehyde reduction (e.g., 170° C.-180° C.) seem to be insufficient to increase the intrinsic viscosity of the polyethylene terephthalate polymers. That is, post-crystallization heat treatment at about 170° C. eliminates acetaldehyde but does not promote further polymerization (i.e., solid state polymerization).

Alternatively, to reduce acetaldehyde content the polyethylene terephthalate pellets may be subjected to recirculated inert gas (or single-pass inert gas) having a temperature of less than about 240° C. (e.g., 170-230° C.). Unlike air, inert gas may be employed at higher temperatures without promoting polymer degradation. Those having ordinary skill in the art will appreciate that such higher temperatures (e.g., 220-240° C.) may promote solid state polymerization. In some instances (e.g., where the polymer has low acetaldehyde content after initial crystallization), the relatively shorter residence times necessary to reduce acetaldehyde content to less than about 2 ppm may be insufficient to promote substantially more polymerization. Those having ordinary skill in the art will appreciate that lower temperatures (e.g., 170-175° C.) necessitate longer residence times.

Those having ordinary skill in the art will appreciate that recirculated air or recirculated inert gas may be cleaned, for instance, using molecular sieves, glycol sprays, or heated catalyst beds (e.g., platinum catalyst bed), or via partial recirculation with that portion not recirculated being burned (e.g., in a heat transfer medium heater.) Those having ordinary skill in the art will likewise appreciate that unit operations employing single-pass air may further employ heat exchangers to recover residual heat.

Finally, those having ordinary skill in the art will appreciate that acetaldehyde can be achieved by subjecting the polyethylene terephthalate pellets to reduced pressures of less than about 100 torr (e.g., 25-75 mm Hg), typically less than 30 torr (e.g., 10-25 mm Hg), more typically less than 15 torr (e.g., 2-10 mm Hg) and most typically less than 2 torr (e.g., 1 mm Hg or less). Such unit operations may be performed as batch operations, semi-continuous operations, or continuous operations (e.g., using a rotary air lock mechanism).

Although the prior exemplary discussion suggests a continuous production process, it will be understood that the invention is not so limited. The teachings disclosed herein may be applied to semi-continuous processes and even batch processes.

To achieve efficient melt phase polycondensation it is necessary to reduce the carboxyl end group concentration of the polyethylene terephthalate prepolymers (or polymers) that are fed to the falling film reactor system. If the carboxyl end group concentration is too high, achieving polyethylene terephthalate polymers having elevated intrinsic viscosities (e.g., 0.80 dL/g or more) may be impractical. In brief, under conditions that are too acidic, the equilibrium between the carboxyl end groups and alcohol end groups can render the polycondensation reaction kinetics most unfavorable.

The inventors have determined that this is especially critical in falling film reactor systems. In falling film reactor systems, control over reaction time and active surface-area generation is limited, rendering the achievement of target molecular weight difficult. As a practical matter, given a typical falling film reactor design, the variable process parameters are limited to (i) the incoming feed composition (e.g., intrinsic viscosity, carboxyl end group concentration and additives, such as catalysts, stabilizers, chain-extenders, and branching agent) and properties (e.g., inlet temperature and melt viscosity) and (ii) reactor pressure (i.e., to facilitate ethylene glycol removal).

By way of comparison, conventional melt polymerizers can readily control additional process parameters to achieve target molecular weights. For instance, in conventional polyester systems, reactor temperature affects reactivity, mechanical agitation affects surface-area generation, and vessel level affects residence time.

In general, there are two broad ways to control carboxyl end group concentration: (i) time-temperature relationships and (ii) chemical relationships. With respect to the former, increasing residence time will reduce carboxyl end group concentration. Increasing reaction temperatures will do the same, but will also encourage side reactions that lead to unwanted byproducts. With respect to the latter, it has been noted that reducing the acidity of the esterification reaction can be achieved using excess ethylene glycol. This, however, can promote the formation of diethylene glycol, which lowers the resin's softening point, and may increase residence times within the esterification vessel(s). It follows that removing ethylene glycol from polycondensation will likewise increase carboxyl end group concentration, as will maintaining water within the polymer melt.

In accordance with the present invention, desirable carboxy end group concentrations may be determined at various intrinsic viscosities based on total-end-group concentrations. Those having ordinary skill in the art will know that polycondensation can proceed so long as the carboxyl end group concentration is less than 100 percent of the total end groups. At a particular polyethylene terephthalate molecular weight (i.e., intrinsic viscosity), however, the greatest carboxyl-end-group concentration that will facilitate acceptable melt reactivity (hereinafter referred to as the “effective maximum carboxyl-end-group concentration”) should not exceed 50 percent of the total-end-group concentration.

Total-end-group concentration (and thus effective maximum carboxyl-end-group concentration) may be indirectly described by the Mark-Houwink equation (below):

M=([η]/K)^{1/a}
wherein:
[η]=intrinsic viscosity (dL/g),
K=0.00017 dL/g; and
a=0.83 dL/g (orthochlorophenol solvent at 25° C.)

Those having ordinary skill in the art will further appreciate that polyethylene terephthalate possesses two reactive end groups (i.e., equivalents) per mole and, therefore, total end groups in the amount of 2,000,000 microequivalents per mole. It follows that dividing total end groups (i.e., 2,000,000 μeq/mol) by the molecular weight (M) of the polyethylene terephthalate prepolymers or polymers (as calculated by the Mark-Houwink equation) yields total-end-group concentration on a mass basis (i.e., microequivalents per gram—μeq/g).

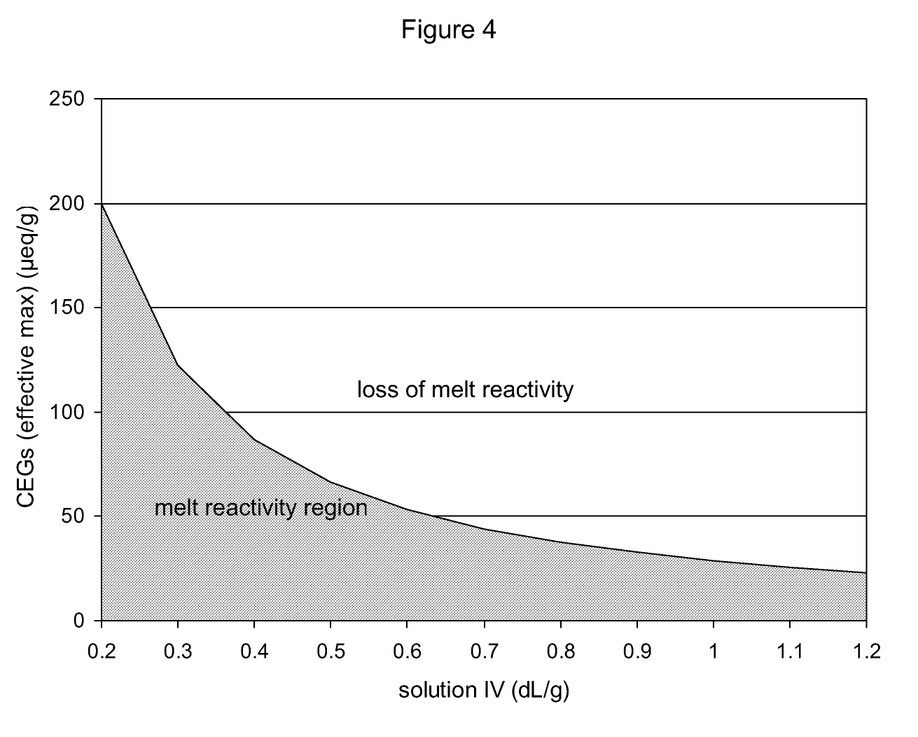

FIG. 4 depicts carboxyl-end-group concentrations for polyethylene terephthalate as a function of solution intrinsic viscosity according to the present invention. FIG. 4 illustrates that melt reactivity is achieved a given intrinsic viscosity only if the carboxyl-end-group concentration is less than the effective maximum carboxyl-end-group concentration (denoted as the “melt reactivity region”). See Polymer Handbook (3^{rd} Edition 1989). Outside of the region of melt reactivity depicted in FIG. 4, the ratio of hydroxyl end groups to carboxyl end groups is less than 1.0 and polycondensation significantly slows (i.e., as a practical matter there will be no further substantial polymer chain propagation).

In most instances, at a given intrinsic viscosity, the operating range is between about 35 percent and 100 percent of the effective maximum carboxyl-end-group concentration as calculated by the Mark-Houwink equation (e.g., between about 50 percent and 90 percent).

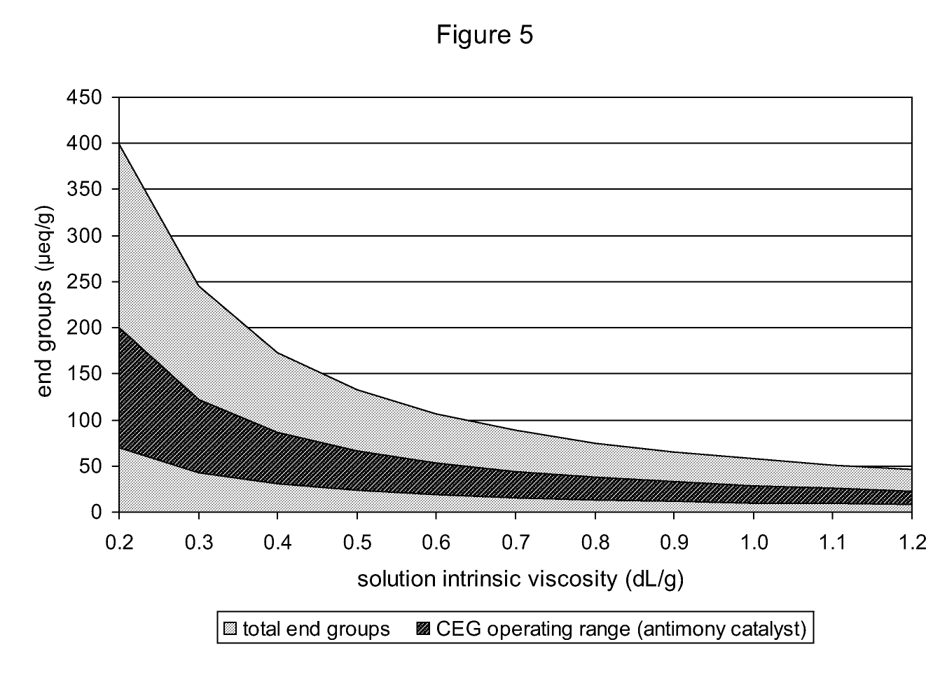

Stated otherwise, at a given intrinsic viscosity, the operating range is between about 15 percent and 50 percent of the total-end-group concentration as calculated by the Mark-Houwink equation (e.g., between about 15 percent and 45 percent, typically between about 25 percent and 45 percent). More typically, at a given intrinsic viscosity, the operating range is between about 30 percent and 45 percent of the total-end-group concentration (e.g., between about 35 percent and 40 percent). FIG. 5 depicts (i) total-end-group concentrations for polyethylene terephthalate as a function of solution intrinsic viscosity and (ii) exemplary carboxyl-end-group concentrations for antimony-catalyzed polyethylene terephthalate as a function of solution intrinsic viscosity (i.e., between 17.5 and 50 percent of total-end-group concentrations).

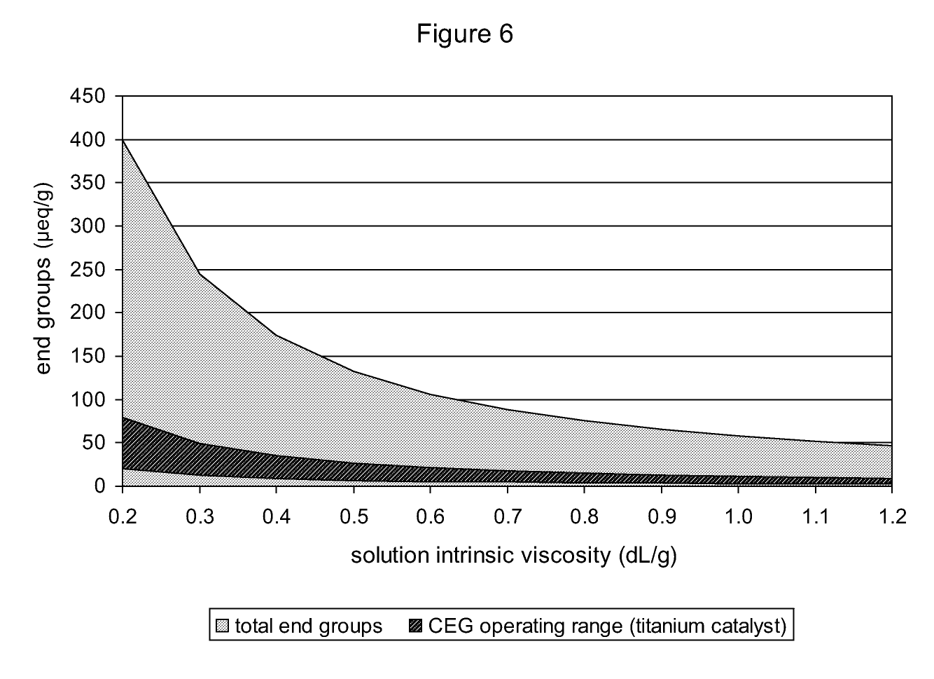

It has been observed that, compared with antimony-catalyzed polyethylene terephthalate prepolymers and polymers, the synthesis of titanium-catalyzed polyethylene terephthalate prepolymers and polymers yields lower carboxyl end group concentrations. Accordingly, for titanium-catalyzed polyethylene terephthalate prepolymers at a given intrinsic viscosity, the operating range is less than about 25 percent of the total-end-group concentration as calculated by Mark-Houwink equation, more typically between about 5 percent and 20 percent (e.g., between about 10 and 15 percent). FIG. 6 depicts (i) total-end-group concentrations for polyethylene terephthalate as a function of solution intrinsic viscosity and (ii) exemplary carboxyl-end-group concentrations for titanium-catalyzed polyethylene terephthalate as a function of solution intrinsic viscosity (i.e., between 5 and 20 percent of total-end-group concentrations).

The carboxyl end group concentration of the intermediate product that is to undergo falling film melt polycondensation may be targeted, for example, by controlling the mole ratio of ethylene glycol to terephthalic acid at the onset of esterification (i.e., esterification feed ratio). Those having ordinary skill in the art will appreciate that, as noted previously, other process parameters (e.g., pressure, temperature, residence time, glycol and/or water removal) can be manipulated, too, to achieve an intermediate product having a carboxyl end group concentration that is appropriate for efficient falling film melt polycondensation.

In accordance with FIG. 4, for processes in which polyethylene terephthalate prepolymers achieved during esterification are fed directly to a falling film reactor, at the inlet to the first falling film reactor the polyethylene terephthalate prepolymers should have a total-end-group concentration of less than about 1000 microequivalents per gram and typically less than about 700 microequivalents per gram (e.g., a carboxy end group concentration of between about 100 and 500 microequivalents per gram for antimony-catalyzed polyethylene terephthalate prepolymers).

Also according to FIG. 4, for processes in which polyethylene terephthalate prepolymers that are achieved during initial polycondensation are fed to a falling film reactor, at the inlet to the first falling film, reactor polyethylene terephthalate prepolymers having (i) an intrinsic viscosity of about 0.30 dL/g should have a carboxyl end group concentration of less than about 125 microequivalents per gram (e.g., between about 80 and 110 microequivalents per gram for antimony-catalyzed polyethylene terephthalate prepolymers); (ii) an intrinsic viscosity of about 0.35 dL/g should have a carboxyl end group concentration of less than about 100 microequivalents per gram (e.g., between about 60 and 90 microequivalents per gram for antimony-catalyzed polyethylene terephthalate prepolymers); and (iii) an intrinsic viscosity of about 0.40 dL/g should have a carboxyl end group concentration of less than about 85 microequivalents per gram (e.g., between about 50 and 75 microequivalents per gram for antimony-catalyzed polyethylene terephthalate prepolymers).

Also according to FIG. 4, in processes in which polyethylene terephthalate polymers achieved during initial polycondensation are fed to a falling film reactor, at the inlet to the first falling film reactor, polyethylene terephthalate polymers having an intrinsic viscosity of about 0.45 dL/g should have a carboxyl end group concentration of less than about 75 microequivalents per gram (e.g., between about 25 and 75 microequivalents per gram for antimony-catalyzed polyethylene terephthalate prepolymers), typically less than about 70 microequivalents per gram (e.g., between about 55 and 65 microequivalents per gram for antimony-catalyzed polyethylene terephthalate prepolymers), and polyethylene terephthalate polymers having an intrinsic viscosity of about 0.60 dL/g should have a carboxyl end group concentration of less than about 55 microequivalents per gram (e.g., between about 20 and 55 microequivalents per gram for antimony-catalyzed polyethylene terephthalate prepolymers), typically less than about 50 microequivalents per gram (e.g., between about 35 and 45 microequivalents per gram for antimony-catalyzed polyethylene terephthalate prepolymers).

In another aspect, the invention includes introducing an inert gas to the polyethylene terephthalate prepolymers or polyethylene terephthalate polymers prior to the falling film melt polycondensation. It is believed that using a mixer to introduce an inert gas, such as nitrogen or carbon dioxide, to the polyethylene terephthalate prepolymers or polymers can significantly increase surface area (e.g., via foaming), thereby facilitating falling film melt polycondensation. Condensable inert gases, in particular, may be selectively employed to increase surface area of the polyethylene terephthalate prepolymers or polymers.

In this regard, the following commonly assigned patent applications, each of which is hereby incorporated by reference in its entirety, embrace foamed polymers: Ser. No. 10/813,893, for Low Density Light Weight Filament and Fiber, filed Mar. 31, 2004, (and published Oct. 6, 2005, as Publication No. 2005/0221075 A1); Ser. No. 11/091,413, for Low Density Light Weight Filament and Fiber, filed Mar. 29, 2004, (and published Nov. 3, 2005, as Publication No. 2005/0244627); Ser. No. 11/244,687, for Low Density Light Weight Filament and Fiber, filed Oct. 5, 2005, (and published Mar. 16, 2006, 2005, as Publication No. 2006/0057359); International Patent Application No. PCT/US05/10870 for Low Density Light Weight Filament and Fiber, filed Mar. 30, 2005, (and published Oct. 20, 2005, as Publication No. WO 2005/098101) and International Patent Application No. PCT/US06/007527 for Low Density Foamed Polymers, filed Feb. 27, 2006 (and published Sep. 8, 2006, as Publication No. WO 2006/094163).

In yet another aspect, the invention embraces further polycondensation in the solid phase. Solid state polymerization may be employed any time after falling film melt polycondensation, of course, but might be most appropriate to achieve high intrinsic viscosities that cannot be readily obtained using a series of falling film reactors. For example, employing solid state polymerization might be especially practical to achieve polyester resins that are suitable for use as tire cord or in extrusion-blow molding operations, each of which requires very high molecular weights (e.g., 0.9-1.1 dL/g).

In yet another aspect, the invention embraces coupling the falling film reactor system with article-forming unit operations (i.e., requiring no pelletization or crystallization operations). The polymer melt that exits the last falling film reactor in the falling film reactor system may be formed, for instance, into molded products or foamed products. In particular, it is envisioned that the falling film melt reactors could be coupled with unit operations for forming preforms, bottles, films, sheets, and fibers.

In yet another aspect, the invention embraces polyethylene terephthalate resins that are formed via falling film melt polycondensation. As noted, such resins are suitable not only for preforms, bottles, and other containers, but other articles as well (e.g., fibers, films, and 1+ millimeter sheets).

The polyethylene terephthalate resins formed according to the falling film melt polycondensation process of present invention generally possess an exemplary intrinsic viscosity of more than about 0.70 dL/g or less than about 0.90 dL/g, or both (i.e., between about 0.70 dL/g and 0.90 dL/g). Those having ordinary skill in the art will appreciate, however, that during injection molding operations polyester resins tend to lose intrinsic viscosity (e.g., an intrinsic viscosity loss of about 0.02-0.06 dL/g from chip to preform).

For some applications the polyethylene terephthalate may have an intrinsic viscosity of more than about 0.78 dL/g (e.g., 0.81 dL/g) or less than about 0.86 dL/g (e.g., 0.84 dL/g), or both (i.e., between about 0.78 dL/g and 0.86 dL/g).

For polyester resins that are capable of forming high-clarity, hot-fill preforms and bottles, the polyethylene terephthalate generally has an intrinsic viscosity of less than about 0.86 dL/g, such as between about 0.72 dL/g and 0.84 dL/g. For example, the polyethylene terephthalate may have an intrinsic viscosity of more than about 0.68 dL/g or less than about 0.80 dL/g, or both (i.e., between about 0.68 dL/g and 0.80 dL/g). Typically, the polyethylene terephthalate has an intrinsic viscosity of more than about 0.75 dL/g as well (i.e., between about 0.75 dL/g and 0.78 dL/g or, more likely, between about 0.78 dL/g and 0.82 dL/g). For preforms used to make hot-fill bottles, heat-setting performance diminishes at higher intrinsic viscosity levels and mechanical properties (e.g., stress cracking, drop impact, and creep) decrease at lower intrinsic viscosity levels (e.g., less than 0.6 dL/g).

For polyester resins that are capable of forming high-strength, high-clarity carbonated soft drink preforms and bottles, the polyethylene terephthalate typically has an intrinsic viscosity of more than about 0.72 dL/g or less than about 0.88 dL/g, or both (i.e., between about 0.72 dL/g and 0.84 dL/g). The polyethylene terephthalate may have an intrinsic viscosity of more than about 0.78 dL/g, more typically an intrinsic viscosity of between about 0.80 dL/g and 0.84 dL/g.

For water bottles and other applications that do not demand high strength (e.g., some sheets and films), the polyethylene terephthalate may have an intrinsic viscosity of more than about 0.60 dL/g (e.g., between about 0.60 dL/g and 0.65 dL/g), typically more than about 0.72 dL/g or less than about 0.78 dL/g (e.g., 0.74-0.76 dL/g), or both (i.e., between about 0.72 dL/g and 0.78 dL/g). For some bottle applications it may be possible to employ resins having even lower intrinsic viscosities (e.g., between about 0.50 dL/g and 0.60 dL/g), albeit at reduced bottle physical and thermal properties.

For polyester fibers (and some films and bottles), the polyethylene terephthalate typically has an intrinsic viscosity of between about 0.50 dL/g and 0.70 dL/g and typically an intrinsic viscosity between about 0.60 dL/g and 0.65 dL/g (e.g., 0.62 dL/g).

As noted, for tire cord and extrusion-blow molding applications the polyethylene terephthalate may require an intrinsic viscosity of more than about 0.9 dL/g.

Those having ordinary skill in the art will appreciate that most commercial polyethylene terephthalate polymers are, in fact, modified polyethylene terephthalate polyesters. Indeed, the polyethylene terephthalate resins described herein are typically modified polyethylene terephthalate polyesters that include less than about 12 mole percent comonomer substitution or more than about 2 mole percent comonomer substitution, or both (e.g., between about 3 and 8 mole percent). In this regard, the modifiers in the terephthalate component and the diol component (i.e., the terephthalate moiety and the diol moiety) are typically randomly substituted in the resulting polyester resin.

As used herein, the term “comonomer” is intended to include monomeric and oligomeric modifiers (e.g., polyethylene glycol).

To achieve polyester compositions according to the present falling film melt polycondensation process, a molar excess of the diol component is reacted with the terephthalate component (i.e., the diol component is present in excess of stoichiometric proportions). As discussed previously, in reacting a diacid component and a diol component via a direct esterification reaction, (i) the diacid component typically includes at least about 70 mole percent terephthalic acid, more typically at least about 80 mole percent terephthalic acid and most typically at least about 90 mole percent terephthalic acid, and (ii) the diol component typically includes at least about 65 mole percent ethylene glycol (e.g., 70 mole percent or more), more typically at least about 80 mole percent ethylene glycol, and most typically at least about 90 mole percent ethylene glycol. Moreover, the molar ratio of the diacid component and the diol component is typically between about 1.0:1.0 and 1.0:1.6. The diol component usually forms the majority of terminal ends of the polymer chains and so is present in the resulting polyester composition in slightly greater fractions.

As used herein, the term “diol component” refers primarily to ethylene glycol, but can include other diols besides ethylene glycol (e.g., diethylene glycol, polyalkylene glycols such as polyethylene glycol, 1,3-propane diol, 1,4-butane diol, 1,5-pentanediol, 1,6-hexanediol, propylene glycol, 1,4-cyclohexane dimethanol (CHDM), neopentyl glycol, 2-methyl-1,3-propanediol, 2,2,4,4-tetramethyl-1,3-cyclobutanediol, adamantane-1,3-diol, 3,9-bis(1,1-dimethyl-2-hydroxyethyl)-2,4,8,10-tetraoxaspiro[5.5]undecane, and isosorbide).

The term “terephthalate component” broadly refers to diacids and diesters that can be used to prepare polyethylene terephthalate. In particular, the terephthalate component mostly includes either terephthalic acid or dimethyl terephthalate, but can include diacid and diester comonomers as well. In other words, the “terephthalate component” is either a “diacid component” or a “diester component.”

The term “diacid component” refers somewhat more specifically to diacids (e.g., terephthalic acid) that can be used to prepare polyethylene terephthalate via direct esterification. The term “diacid component,” however, is intended to embrace relatively minor amounts of diester comonomer (e.g., mostly terephthalic acid and one or more diacid modifiers, but optionally with some diester modifiers, too). Although the term “diester component” refers somewhat more specifically to diesters (e.g., dimethyl terephthalate) that can be used to prepare polyethylene terephthalate via ester exchange, it is also intended to embrace relatively minor amounts of diacid comonomer (e.g., mostly dimethyl terephthalate and one or more diester modifiers, but optionally with some diacid modifiers, too).

The terephthalate component, in addition to terephthalic acid or its dialkyl ester (i.e., dimethyl terephthalate), can include modifiers such as isophthalic acid or its dialkyl ester (i.e., dimethyl isophthalate), 2,6-naphthalene dicarboxylic acid or its dialkyl ester (i.e., dimethyl 2,6 naphthalene dicarboxylate), adipic acid or its dialkyl ester (i.e., dimethyl adipate), succinic acid, its dialkyl ester (i.e., dimethyl succinate), or its anhydride (i.e., succinic anhydride), or one or more functional derivatives of terephthalic acid. The terephthalate component may also include phthalic acid, phthalic anhydride, biphenyl dicarboxylic acid, cyclohexane dicarboxylic acid, anthracene dicarboxylic acid, adamantane 1,3-dicarboxylic acid, glutaric acid, sebacic acid, or azelaic acid.

It will be understood that diacid comonomer will typically be employed when, as is the case in the present falling film melt polycondensation process, the terephthalate component is mostly terephthalic acid (i.e., a diacid component).

For polyethylene terephthalate bottle resins formed according to the present falling film melt polycondensation process, isophthalic acid and diethylene glycol might be typical modifiers. Higher levels of comonomer—especially diethylene glycol—tend to suppress crystalline melting peak temperature (T_{M}). Those having ordinary skill in the art will appreciate that injection molding operations may run faster using polyester resins that possess lower melting points. Accordingly, higher comonomer content may be desirable to achieve polyester resins that deliver faster cycle times during injection molding. Those having ordinary skill in the art will appreciate that, as a modifier, cyclohexane dimethanol efficiently suppresses polymer crystallinity but has poor oxygen permeability properties.

For polyethylene terephthalate fiber resins formed according to the falling film melt polycondensation process, no comonomer substitution is necessary, but where employed, typically includes diethylene glycol or polyethylene glycol.

Finally, additives can be incorporated into the polyethylene terephthalate resins formed according to the present falling film melt polycondensation process. Such additives include stabilizers, compatibilizers, preform heat-up rate enhancers, friction-reducing additives, UV absorbers, inert particulate additives (e.g., clays or silicas), colorants, antioxidants, branching agents, oxygen barrier agents, carbon dioxide barrier agents, oxygen scavengers, flame retardants, crystallization control agents, acetaldehyde reducing agents, impact modifiers, catalyst deactivators, melt strength enhancers, anti-static agents, lubricants, chain extenders, nucleating agents, solvents, fillers, and plasticizers.

The prior discussion of the present invention emphasizes methods of making polyethylene terephthalate resins in falling film reactor systems. The foregoing falling film reactor systems may have application not only to other polyesters (e.g., polytrimethylene terephthalate or polybutylene terephthalate), but also to other condensation polymers (e.g., condensation polymers having carbonyl functionality). Suitable non-polyester condensation polymers according to the present invention include, without limitation, polyurethanes, polyamides, and polyimides.

As used herein, the term “carbonyl functionality” refers to a carbon-oxygen double bond that is an available reaction site. Condensation polymers having carbonyl functionality are typically characterized by the presence of a carbonyl functional group (i.e., C═O) with at least one adjacent hetero atom (e.g., an oxygen atom, a nitrogen atom, or a sulfur atom) functioning as a linkage within the polymer chain. Accordingly, “carbonyl functionality” is meant to embrace various functional groups including, without limitation, esters, urethanes, amides, and imides.

As will be understood by those of ordinary skill in the art, oligomeric precursors to condensation polymers may be formed by reacting a first polyfunctional component and a second polyfunctional component. For example, oligomeric precursors to polyurethanes may be formed by reacting diisocyanates and diols, oligomeric precursors to polyamides may be formed by diacids and diamines, and oligomeric precursors to polyimides may be formed by reacting dianhydrides and diamines. See, e.g., Odian, Principles of Polymerization, (Second Edition 1981). These kinds of reactions are well understood by those of ordinary skill in the polymer arts and will not be further discussed herein.

It will be further understood by those having ordinary skill in the art that certain monomers possessing multi-functionality can self-polymerize to yield condensation polymers. For example, amino acids and nylon salts are each capable of self-polymerizing into polyamides, and hydroxy acids (e.g., lactic acid) can self-polymerize into polyesters (e.g., polylactic acid).

Therefore, in yet another aspect and in accordance with the foregoing, the present invention further embraces methods for making condensation polymers via melt phase polycondensation in falling film reactor systems.

In the specification and the figures, typical embodiments of the invention have been disclosed. Specific terms have been used only in a generic and descriptive sense, and not for purposes of limitation.

1. A method for making polyethylene terephthalate resin via falling film melt polycondensation, comprising:
reacting in an esterification reaction a diacid component that includes mostly terephthalic acid and a diol component that includes mostly ethylene glycol to yield an intermediate product that includes monomers and oligomers of terephthalic acid and diacid modifiers, and ethylene glycol and diol modifiers;
thereupon introducing the intermediate product into a falling film reactor having substantially static internal packing that is capable of (i) increasing the effective surface-area of the intermediate product and (ii) promoting degasification of the intermediate product; and
forming the intermediate product into a film, the film descending via gravity through the falling film reactor's internal packing (i) to promote surface generation of the intermediate product, (ii) to encourage degasification of the intermediate product, and (iii) to polymerize the intermediate product via steady-state melt phase polycondensation to form polyethylene terephthalate resin;
wherein the surface generation of the intermediate product within the falling film reactor is achieved substantially passively via gravitational flow through the falling film reactor's substantially static internal packing.

2. A method according to claim 1, wherein the step of reacting in an esterification reaction a diacid component that includes mostly terephthalic acid and a diol component that includes mostly ethylene glycol comprises reacting a diacid component that includes at least about 70 mole percent terephthalic acid and a diol component that includes at least about 65 mole percent ethylene glycol.

3. A method according to claim 1, wherein:
the introduction of the intermediate product into the falling film reactor comprises introducing the intermediate product having an intrinsic viscosity of at least about 0.25 dL/g; and
the polymerization of the intermediate product in a falling film reactor via steady-state melt phase polycondensation achieves an intrinsic viscosity lift of more than about 0.10 dL/g.

4. A method according to claim 1, wherein the polymerization of the intermediate product in the falling film reactor comprises steady-state, melt phase polycondensation in a substantially vertical falling film reactor to increase the intrinsic viscosity of the intermediate product by 0.15 dL/g or more.

5. A method according to claim 1, wherein the polymerization of the intermediate product in the falling film reactor lifts the intrinsic viscosity of the intermediate product by 0.25 dL/g or more.

6. A method according to claim 1, wherein the polymerization of the intermediate product in the falling film reactor yields polyethylene terephthalate resin having an intrinsic viscosity of at least about 0.60 dL/g.

7. A method according to claim 1, wherein the polymerization of the intermediate product in the falling film reactor yields polyethylene terephthalate resin having an intrinsic viscosity of between about 0.70 dL/g and 1.0 dL/g.

8. A method according to claim 1, further comprising (i) pelletizing the polyethylene terephthalate resin and (ii) thereafter subjecting the pelletized polyethylene terephthalate resin to air having a temperature of less than about 185° C. for a period sufficient to reduce the acetaldehyde content of the polyethylene terephthalate resin to less than about 5 ppm.

9. A method according to claim 8, wherein, to reduce acetaldehyde, the pelletized polyethylene terephthalate resin is subjected to air having a dew point of more than −20° C.

10. A method according to claim 8, wherein the pelletized polyethylene terephthalate resin is subjected to air having (i) a temperature of less than about 180° C. and (ii) a dew point greater than about 0° C. to reduce the acetaldehyde content of the polyethylene terephthalate resin to less than about 5 ppm.

11. A method according to claim 1, further comprising the step of forming the polyethylene terephthalate resin into a preform, a bottle, a sheet, a film, fiber, or other article.

12. A method for making a polyethylene terephthalate resin via falling film melt polycondensation, comprising:
reacting in an esterification reaction a diacid component that includes mostly terephthalic acid and a diol component that includes mostly ethylene glycol to form monomers and oligomers of terephthalic acid and diacid modifiers, and ethylene glycol and diol modifiers;
polymerizing the monomers and oligomers via melt phase polycondensation to yield an intermediate product that includes polyethylene terephthalate prepolymers and/or polyethylene terephthalate polymers;
introducing the intermediate product into a falling film reactor having substantially static internal packing that is capable of (i) increasing the effective surface-area of the intermediate product and (ii) promoting degasification of the intermediate product; and
forming the intermediate product into a film, the film descending via gravity through the falling film reactor's internal packing (i) to promote surface generation of the intermediate product, (ii) to encourage degasification of the intermediate product, and (iii) to polymerize the intermediate product via steady-state melt phase polycondensation to form polyethylene terephthalate resin;
wherein the surface generation of the intermediate product within the falling film reactor is achieved substantially passively via gravitational flow through the falling film reactor's substantially static internal packing.

13. A method according to claim 12, wherein the step of reacting in an esterification reaction a diacid component that includes mostly terephthalic acid and a diol component that includes mostly ethylene glycol comprises reacting a diacid component that includes at least about 70 mole percent terephthalic acid and a diol component that includes at least about 65 mole percent ethylene glycol.

14. A method according to claim 12, wherein the polymerization of the intermediate product in the falling film reactor comprises steady-state, melt phase polycondensation in a substantially vertical falling film reactor to increase the intrinsic viscosity of the intermediate product by 0.15 dL/g or more.

15. A method according to claim 12, wherein the polymerization of the intermediate product in the falling film reactor lifts the intrinsic viscosity of the intermediate product by 0.25 dL/g or more.

16. A method according to claim 12, wherein, during steady-state melt phase polycondensation, the intermediate product is at its maximum temperature in the falling film reactor near the reactor inlet.

17. A method according to claim 12, wherein:
one or more melt phase polycondensation steps are antimony-catalyzed polymerizations; and
the carboxyl end group content of the intermediate product at the inlet to the falling film reactor is between about 25 and 45 percent of the total-end-group concentration.

18. A method according to claim 12, wherein:
the melt phase polycondensation steps are antimony-catalyzed polymerizations; and
the polymerization of the intermediate product in the falling film reactor yields polyethylene terephthalate resin having a carboxyl end group content that is between about 15 and 45 percent of the total-end-group concentration.

19. A method according to claim 12, wherein:
one or more melt phase polycondensation steps are titanium-catalyzed polymerizations; and
the carboxyl end group content of the intermediate product at the inlet to the falling film reactor is between about 5 and 20 percent of the total-end-group concentration.

20. A method according to claim 12, wherein:
the melt phase polycondensation steps are titanium-catalyzed polymerizations; and
the polymerization of the intermediate product in the falling film reactor yields polyethylene terephthalate resin having a carboxyl end group content that is between about 5 and 20 percent of the total-end-group concentration.

21. A method according to claim 12, wherein the polymerization of the intermediate product in the falling film reactor yields polyethylene terephthalate resin having an intrinsic viscosity of at least about 0.60 dL/g.

22. A method according to claim 12, wherein the polymerization of the intermediate product in the falling film reactor yields polyethylene terephthalate resin having an intrinsic viscosity of between about 0.70 dL/g and 1.0 dL/g.

23. A method according to claim 12, further comprising (i) pelletizing the polyethylene terephthalate resin and (ii) thereafter subjecting the pelletized polyethylene terephthalate resin to air having a temperature of less than about 185° C. for a period sufficient to reduce the acetaldehyde content of the polyethylene terephthalate resin to less than about 5 ppm.

24. A method according to claim 23, wherein, to reduce acetaldehyde, the pelletized polyethylene terephthalate resin is subjected to air having a dew point of more than −20° C.

25. A method according to claim 23, wherein the pelletized polyethylene terephthalate resin is subjected to air having (i) a temperature of less than about 180° C. and (ii) a dew point greater than about 0° C. to reduce the acetaldehyde content of the polyethylene terephthalate resin to less than about 5 ppm.

26. A method according to claim 12, further comprising the step of forming the polyethylene terephthalate resin into a preform, a bottle, a sheet, a film, fiber, or other article.
